(19) United States
(12) Patent Application Publication
(10) Pub. No.: US 2006/0223481 A1
(43) Pub. Date: Oct. 5, 2006

(54) Integrated circuit layout for a television tuner

(76) Inventors: Takatsugu Kamata, Yokohama (JP); Kazunori Okui, Newark, CA (US); Kazuyoshi Tanaka, Yokohama (JP)

Correspondence Address: STATTLER JOHANSEN & ADELI LLP, 540 UNIVERSITY AVENUE, SUITE 350, PALO ALTO, CA, 94301, US

(21) Appl. No.: 11/373,372

(22) Filed: Mar. 10, 2006

Related U.S. Application Data
(60) Provisional application No. 60/660,818, filed on Mar. 11, 2005.

(51) Int. Cl. H04B 1/26

(52) U.S. Cl. 455/313

(57) ABSTRACT

An integrated circuit including one or more radio frequency (RF) filters to receive an RF signal and to generate a filtered RF signal and a down conversion stage coupled to the RF filters, the down conversion stage further including a local oscillator circuit and an intermediate frequency (IF) filter, the local oscillator circuit being electrically shielded from the IF filter. Each RF filter is a discrete inductive-capacitive (LC) filter, further including a plurality of discrete inductive banks and capacitive banks. The integrated circuit further includes a plurality of input pads to receive the RF signal, each capacitive bank of the RF filter being located adjacently to respective input pads within the circuit, and further includes a plurality of capacitor devices coupled in parallel, with capacitor devices having a lower capacitance value being positioned adjacently to said respective input pads and remaining capacitor devices being positioned in increased order of their capacitance value away from said respective input pads.

### CROSS-REFERENCE TO RELATED APPLICATIONS

This application claims the benefit of U.S. Provisional Patent Application Ser. No. 60/660,818, filed on Mar. 11, 2005, and entitled “An integrated Circuit Layout for a Television Tuner.”

### BACKGROUND OF THE INVENTION

1. Field of the Invention:

The invention relates generally to the field of electronic circuits, and, more particularly, to an integrated circuit layout for a television tuner circuit.

2. Art Background:

Wide band receivers are designed to process input signals with a wide range of input carrier frequencies. For example, television receivers must be capable of processing input television signals with carrier frequencies ranging from 55 MHz to 880 MHz. Typically, receivers employ filters to condition both input signals and internally-generated reference signals. For example, band pass, notch, and low pass are types of filters employed in receivers. The frequency response of a filter refers to the characteristics of the filter that condition the signal input to the filter. For example, a band pass filter may attenuate an input signal across a predetermined band of frequencies above and below a center frequency of the filter.

Receivers also typically employ a local oscillator to produce a signal for mixing with the conditioned input signal to produce a carrier signal at an intermediate frequency. The local oscillator typically includes one or more oscillators, such as, for example, voltage controlled oscillators, to produce mixing signals having such a broad range of frequencies.

It would be advantageous to integrate a receiver onto a single integrated circuit layout. However, the local oscillator needs to be shielded from other circuit components within the receiver, in order to maintain the noise performance and to ensure the stability of the local oscillator circuit.

### SUMMARY OF THE INVENTION

An integrated circuit for a television tuner is described. The integrated circuit includes one or more radio frequency (RF) filters to receive an RF signal and to generate a filtered RF signal, and a down conversion stage coupled to the RF filters, the down conversion stage further including a local oscillator circuit and an intermediate frequency (IF) filter, the local oscillator circuit being electrically shielded from the IF filter. Each RF filter is a discrete inductive-capacitive (LC) filter, further including a plurality of discrete inductive banks and capacitive banks. The integrated circuit further includes a plurality of input pads to receive the RF signal, each capacitive bank of the RF filter being located adjacently to respective input pads within the circuit, and further includes a plurality of capacitor devices coupled in parallel, with capacitor devices having a lower capacitance value being positioned adjacently to said respective input pads and remaining capacitor devices being positioned in increased order of their capacitance value away from said respective input pads.

Other features of the invention will be apparent from the accompanying drawings, and from the detailed description, which follows below.

### BRIEF DESCRIPTION OF THE DRAWINGS

FIG. 1 is a block diagram illustrating a television tuner circuit in which methods of the invention may be implemented;

FIG. 2 is a block diagram illustrating an integrated circuit layout, which incorporates the television tuner circuit, according to one embodiment of the invention;

FIG. 3 is a topological view of the integrated circuit layout, according to one embodiment of the invention;

FIG. 4 is a topological view of a voltage controlled oscillator within the integrated circuit layout, according to one embodiment of the invention;

FIG. 5 is a schematic diagram illustrating a capacitive bank within a radio frequency (RF) filter circuit of the television tuner circuit, according to one embodiment of the invention;

FIG. 6 is a topological view of a portion of the integrated circuit layout, which contains the capacitive banks of the RF filter circuit, according to one embodiment of the invention.

### DETAILED DESCRIPTION

The disclosure of U.S. Provisional Patent Application Ser. No. 60/660,818, filed on Mar. 11, 2005, and entitled “An Integrated Circuit Layout for a Television Tuner,” is expressly incorporated by reference herein in its entirety. Although the invention is described below in terms of specific exemplary embodiments, one skilled in the art will realize that various modifications and alterations may be made to the below embodiments without departing from the spirit and scope of the invention.

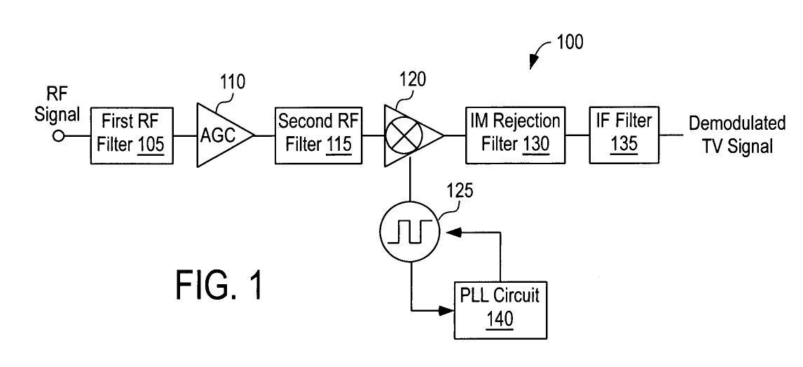

FIG. 1 is a block diagram illustrating a television tuner 100 in which methods of the present invention may be implemented. The television tuner 100 receives a radio frequency (RF) television signal, and generates demodulated baseband television signals (i.e., picture and sound signals). In one embodiment, the television tuner 100 includes a first RF filter circuit 105, an automatic gain control circuit (AGC) 110, a second RF filter circuit 110, a mixer (that includes an AGC) 120, a local oscillator circuit 125, an image rejection filter circuit 130, an intermediate frequency (IF) filter circuit 135, and a phase lock loop (PLL) circuit 140 coupled to the local oscillator 125.

In one embodiment, the first and second RF filters 105 and 115 are discrete inductive-capacitive (LC) filters, each comprised of discrete inductive and capacitive banks. The AGC 110 is coupled between the first and second RF filters and amplifies the signal, output from the first RF filter 105, for input to the second RF filter 115.

In one embodiment, the television tuner 100 further includes a down conversion stage including the mixer 120, the local oscillator circuit 125, the image rejection filter circuit 130, the intermediate frequency (IF) filter circuit 135, and the PLL circuit 140. The local oscillator circuit 125 further comprises an inductive-capacitive (LC) tank voltage controlled oscillator (VCO) circuit, which contains one or more LC filters comprised of discrete inductive and capacitive banks. The LC tank tunes the VCO circuit over a wide range of frequencies. The discrete inductive and capacitive banks are selected to tune the local oscillator circuit 125.

Also in some embodiments, the image rejection filter 130 may be a notch RC filter comprised of resistive and capacitive banks, and the IF filter 135 may be a discrete band pass LC filter comprised of inductive and capacitive banks.

The down conversion stage converts the frequency of the filtered RF television signal to an intermediate frequency (IF) that is determined by country standards. Generally, the down conversion stage mixes the input signal with a local oscillator signal to produce the IF signal. The image rejection notch filter 130 filters out the image and the IF band pass filter 135 attenuates signals at frequencies other than around the intermediate frequency.

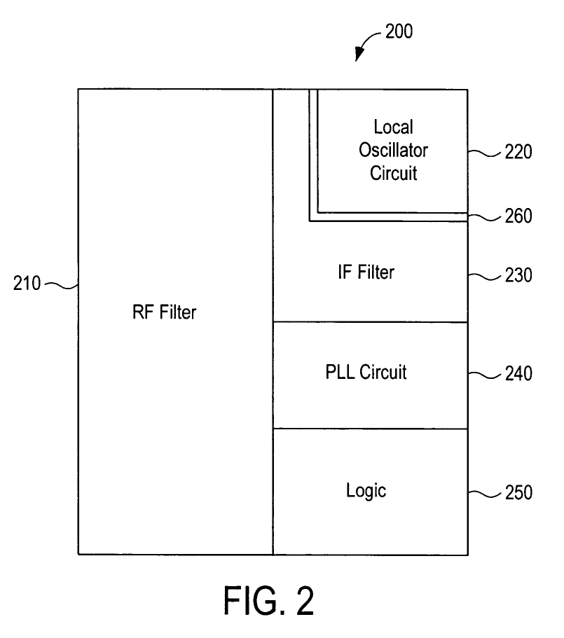

FIG. 2 is a block diagram illustrating an integrated circuit layout, which incorporates the television tuner circuit, according to one embodiment of the invention. As illustrated in FIG. 2, in one embodiment, the television tuner circuit 200 includes one or more RF filters 210, a local oscillator circuit 220, an IF filter 230, a phase lock loop (PLL) circuit 240, and a logic circuit 250. In one embodiment, the RF filters 210, the IF filter 230, the phase lock loop (PLL) circuit 240, and the logic circuit 250 form a tuning circuit. Although the television tuner circuit 200 includes the circuit components described above, it is to be understood that other circuits, components, and/or modules may be used, such as, for example, circuits and modules described in detail in connection with FIG. 1, without departing from the spirit or scope of the invention.

In one embodiment, the local oscillator circuit 220 is electrically shielded from all the circuit components part of the tuning circuit through the use of a shield 260, such as, for example, a metal shield. As shown in FIG. 2, for example, the local oscillator circuit 220 is isolated from the IF filter circuit 230 via multiple metal layers connecting to the substrate of tihe layout and forming the shield 260.

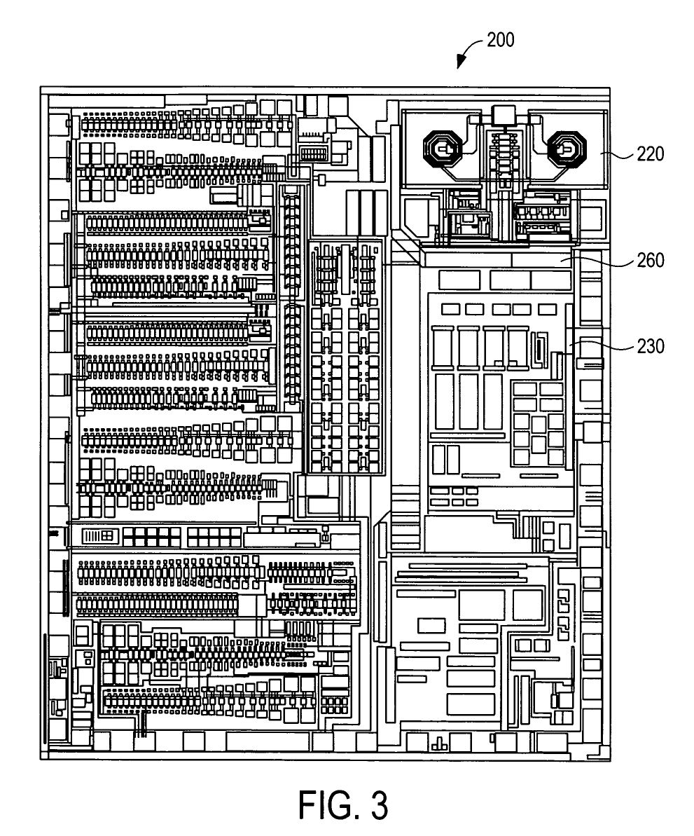

FIG. 3 is a topological view of the integrated circuit layout, according to one embodiment of the invention. FIG. 3 illustrates in further detail the television tuner circuit 200. As shown in FIG. 3, and as similarly described above in connection with FIG. 2, in one embodiment, the television tuner circuit 200 includes the local oscillator circuit 220, which is shielded from the IF filter circuit 230 through the use of a shield 260.

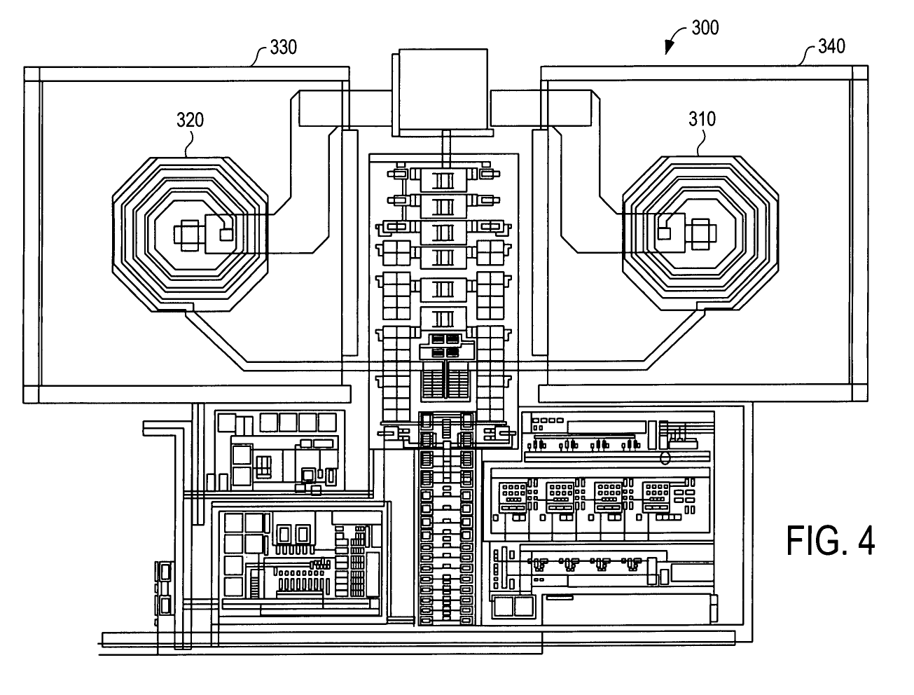

FIG. 4 is a topological view of a voltage controlled oscillator within the integrated circuit layout, according to one embodiment of the invention. As shown in FIG. 4, in one embodiment, the VCO circuit 300 includes inductor devices 310, 320, which further comprise coils of conductors. The inductor devices 310 and 320 are shielded from other circuit components within the television tuner circuit 200, such as, for example, the IF filter circuit 230, through the use of respective electrical shields 330 and 340.

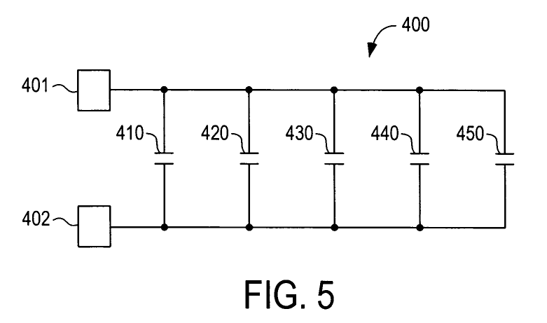

FIG. 5 is a schematic diagram illustrating a capacitive bank within the RF filter circuit 210 of the television tuner circuit 200, according to one embodiment of the invention. As shown in FIG. 5, a capacitive bank 400 includes multiple capacitor devices coupled in parallel, of which five capacitor devices 410 through 450 are shown. Although the capacitive bank 400 includes five capacitor devices, any number of capacitor devices may be used without deviating from the spirit or scope of the invention. The capacitive bank 400 is used to configure the tunable discrete LC filter circuits within the television tuner circuit 200.

In one embodiment, the capacitive bank 400 is located in close proximity to input pads 401 and 402 of the television tuner circuit 200, and the capacitor devices 410 through 450 are positioned such that capacitor devices having a lower capacitance value, for example capacitor devices 410, 420, are located adjacently to the input pads 401 and 402, while the remaining capacitor devices, such as, for example, capacitor devices 430 through 450, are positioned in increased order of their capacitance value away from the input pads 401, 402. The close proximity of the input pads 401, 402 to the capacitive bank 400 thus reduces parasitic acceptance introduced by the leads.

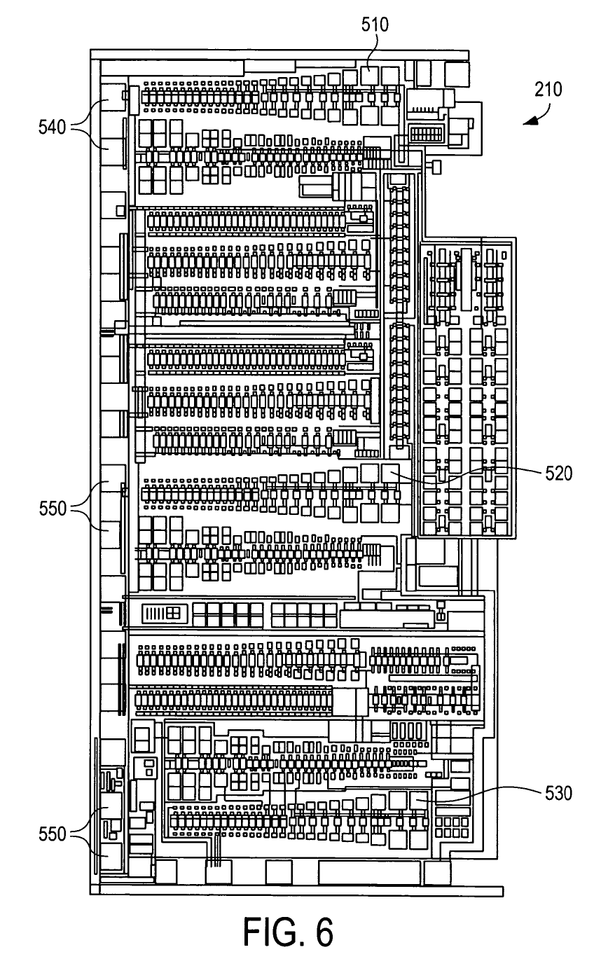

FIG. 6 is a topological view of a portion of the integrated circuit layout, which contains the capacitive banks of the RF filter circuit 210, according to one embodiment of the invention. As shown in FIG. 6, in one embodiment, each capacitive bank 510, 520, and 530 is located adjacently to respective pairs of input pads 540, 550, and 560, such that corresponding capacitor devices having lower capacitance value are located adjacently to the respective pairs of input pads 540, 550, 560 and remaining capacitor devices are positioned in increased order of their capacitance value away from the respective pairs of input pads 540, 550, 560.

What is claimed is:

1. An integrated circuit comprising:
a local oscillator circuit comprising a voltage controlled oscillator and an inductive-capacitive (“LC”) filter, said local oscillator circuit for generating a local oscillator signal for tuning; and
a tuning circuit, coupled to said local oscillator circuit, for tuning an input signal using said local oscillator;
wherein a layout for said integrated circuit shields said local oscillator circuit from said tuning circuit.

2. The integrated circuit as set forth in claim 1, wherein said tuning circuit further comprises:
a down converter, coupled to said local oscillator circuit, for receiving an input signal and said local oscillator signal and for generating an intermediate frequency signal; and
an intermediate frequency filter, coupled to said down converter, for filtering said intermediate frequency signal.

3. The integrated circuit as set forth in claim 1, wherein said tuning circuit further comprises at least one radio frequency (“RF”) filter for filtering an RF input signal.

4. The integrated circuit as set forth in claim 1, wherein said tuning circuit further comprises a logic circuit for tuning a signal.

5. The integrated circuit as set forth in claim 1, wherein said local oscillator circuit and said tuning circuit further comprise a television receiver.

6. The integrated circuit as set forth in claim 3, wherein said at least one RF filter is a discrete inductive-capacitive (LC) filter, each comprising a plurality of discrete inductive banks and capacitive banks.

7. The integrated circuit as set forth in claim 6, further comprising a plurality of input pads to receive said RF signal, each capacitive bank of said plurality of inductive and capacitive banks being located adjacently to respective input pads of said plurality of input pads.

8. The integrated circuit as set forth in claim 7, wherein said each capacitive bank further comprises a plurality of capacitor devices coupled in parallel, with capacitor devices having a lower capacitance value being positioned adjacently to said respective input pads and remaining capacitor devices being positioned in increased order of their capacitance value away from said respective input pads.

9. A capacitive bank in a radio frequency (RF) filter, said capacitive bank comprising:
a plurality of capacitor devices coupled in parallel and positioned adjacently to respective input pads of a plurality of input pads within said RF filter, capacitor devices having a lower capacitance value being positioned adjacently to said respective input pads.

10. The capacitive bank as set forth in claim 9, wherein remaining capacitor devices of said plurality of capacitor devices are positioned in increased order of their capacitance value away from said respective input pads.
